(19) United States
(12) Patent Application Publication
(10) Pub. No.: US 2020/0333684 A1
(43) Pub. Date: Oct. 22, 2020

(54) OPTICAL SYSTEM FOR NARROWING THE BANDWIDTH OF RADIATION

(71) Applicant: Victoria Link Limited, Hamilton (NZ)

(72) Inventors: Shyamal Kush Kanchan Prasad, Sydney, NSW (AU); Nicholas Richard Monahan, Kelburn (NZ); Karen Elisabeth Thorn, Churton Park (NZ); Kai Chen, Karori (NZ); Justin Mark Hodgkiss, Karori (NZ)

(21) Appl. No.: 16/769,554

(22) PCT Filed: Nov. 29, 2018
(86) PCT No.: PCT/NZ2018/050170

§ 371 Date: Jun. 3, 2020

(30) Foreign Application Priority Data
Dec. 4, 2017 (NZ) 737899

(51) Int. Cl. G02F 1/35; H01S 3/00; G02B 27/10; G02F 1/355; G02B 27/30

(52) U.S. Cl. CPC G02F 1/3544; H01S 3/0092; H01S 3/1625; G02F 1/3551; G02B 27/30; G02B 27/1086

(57) ABSTRACT

An optical system for narrowing the bandwidth of a beam of incident radiation includes an optical mixing unit configured to receive a first beam of radiation and a second beam of radiation. The first and second beams are spatially chirped and the first beam is inverted relative to the second beam. The optical mixing unit includes an optical mixing member, which includes a nonlinear optical medium to mix the first and second beams into an output beam having a narrower bandwidth than the beam of incident radiation.

### FIELD OF INVENTION

The invention relates to optical systems for narrowing the bandwidth of radiation. In some embodiments the invention relates to optical systems for reducing the spectral bandwidth of a laser pulse, for example converting a spectrally broad femtosecond laser pulse into a spectrally narrow picosecond pulse.

### BACKGROUND TO THE INVENTION

Generation of narrowband laser pulses, for example intense narrowband picosecond laser pulses, is of significant interest in ultrafast laser applications where high spectral resolution is required, such as time-resolved vibrational pump-probe spectroscopy and sum-frequency generation (SFG) surface spectroscopy. The conversion of femtosecond broadband laser pulses to picosecond narrowband pulses presents challenges because achievable bandwidth compression is typically a trade-off between efficiency and experimental simplicity.

Linear methods of bandwidth compression involve the spectral filtering of a femtosecond broadband laser source, typically in a folded 4f grating filter configuration, to produce picosecond narrowband pulses. Fine tunability of the signal frequency is achievable within the fundamental spectral bandwidth Δω_{FF}. While broadly tunable and relatively experimentally simplistic in design, spectral filtering methods suffer from inherently low power conversion efficiency due to the inversely proportional nature of narrow-bandwidth selection and power throughput, with typical energy losses of the fundamental femtosecond source of about 99.8% to generate picosecond pulses that are sufficiently spectrally narrow.

An alternative method of bandwidth compression utilises the nonlinear phenomena of sum-frequency generation (SFG) whereby two femtosecond pulses at a central frequency ω_{FF} are equally and oppositely temporally chirped with a temporal chirp parameter ±Δτ and mixed in a non-collinear geometry in suitably phase-matched nonlinear crystal to produce a narrowband picosecond pulse at the second harmonic frequency ω_{SH}=(ω_{FF}+Δτ)+(ω_{FF}−Δτ)=2ω_{FF}. The relatively efficient generation of narrowband picosecond pulses has made the SFG method often favoured as a bandwidth compression technique across many spectroscopic applications. Adaptations on this method have also been proposed and demonstrated, including difference-frequency generation mixing of two positively chirped femtosecond pulses with different central frequencies.

While improving power conversion efficiency, to date nonlinear bandwidth compression techniques remain experimentally complex in nature, require expensive optical dispersion components that typically have a large physical footprint and are challenging to tune and optimise. A typical experimental arrangement involves two 4f grating stretcher pairs, and eight passes through a dispersive element are used to generate two pulses of equal and opposite temporal chirp for sum-frequency mixing. Moreover, proportionally matching the chirp parameter of each pulse is achieved by precise alignment of at least two dispersive elements and time-domain methods to characterise the chirp.

### OBJECT OF THE INVENTION

It is an object of the invention to provide an optical system for altering the spectral properties of electromagnetic radiation, for example a pulse of laser light. Alternatively, it is an object to provide an optical system for narrowing the bandwidth of a beam of incident radiation. Alternatively, it is an object to provide a spectrometer comprising a narrow bandwidth beam generator. Alternatively, it is an object to provide a method of controlling the narrowing of the bandwidth of a beam of incident radiation in an optical system. Alternatively, it is an object of the invention to at least provide the public with a useful choice.

### SUMMARY OF THE INVENTION

Aspects of the present invention are directed towards optical systems for altering the spectral properties of electromagnetic radiation, for example a pulse of laser light.

One aspect of the invention is an optical system for reducing the spectral bandwidth of a pulse of laser light, for example, converting a spectrally broad femtosecond laser pulse into a spectrally narrow picosecond pulse.

In one aspect of the invention the invention comprises an optical system for sum-frequency mixing of spatially chirped, or angularly dispersed, beams or pulses of radiation.

Optical systems according to aspects of the invention may be used in optical devices such as example spectrometers, for example Raman spectrometers, pulse generators, pulse converters and quantum information transfer systems.

According to one aspect of the invention there is provided an optical system for narrowing the bandwidth of a beam of incident radiation, the optical system comprising an optical mixing unit configured to receive a first beam of radiation and a second beam of radiation, wherein the first and second beams are spatially chirped and the first beam is inverted relative to the second beam, and wherein the optical mixing unit comprises an optical mixing member comprising a nonlinear optical medium to mix the first and second beams into an output beam having a narrower bandwidth than the beam of incident radiation.

Preferably, the optical system comprises an inversion unit configured to invert the first beam relative to the second beam prior to the beams being received by the optical mixing unit.

Preferably, the optical system comprises at least one spatial chirp unit configured to spatially chirp the incident radiation prior to inversion of the first beam relative to the second beam.

Preferably, the optical system comprises a splitter unit configured to split the incident radiation into the first and second beams.

In one embodiment the at least one spatial chirp unit spatially chirps the incident radiation prior to the incident radiation being split into the first and second beams. In an alternative embodiment the at least one spatial chirp unit spatially chirps the first and second beams after the incident radiation is split into the first and second beams.

Preferably, the at least one spatial chirp unit comprises a dispersion grating. Alternatively, the at least one spatial chirp unit comprises a dispersive prism.

In a preferred embodiment the optical system may comprise a spatial chirp unit adjustment mechanism configured to adjust the orientation and/or position of the at least one spatial chirp unit or part thereof.

Preferably, the splitter unit comprises a beam splitter. In an alternative form, the splitter unit comprises a transmissive dispersion grating.

Preferably, the inversion unit comprises one or more reflecting members.

Preferably the optical system comprises a reflecting member adjustment mechanism configured to adjust the orientation and/or position of at least one of the one or more reflecting members.

In some embodiments, the nonlinear optical medium comprises a nonlinear optical crystal.

Preferably, the optical system comprises a phase matching mechanism configured to substantially phase match the first, second and output beams. It will be understood that, in some embodiments, the phase matching mechanism allows a phase matching condition for nonlinear conversions such as sum frequency generation to occur. More preferably the phase matching mechanism comprises an optical mixing unit adjustment mechanism configured to adjust the orientation and/or position of the optical mixing unit or part thereof. For example, the optical mixing unit adjustment mechanism may be adapted to adjust the orientation and/or position of the nonlinear optical medium to substantially phase match the first, second and output beams. And/or the optical mixing unit adjustment mechanism is adapted to rotate the nonlinear optical medium to substantially phase match the first, second and output beams.

Preferably, the optical mixing unit comprises one or more focussing members configured to focus the first and second split beams received by the optical mixing unit.

In a preferred embodiment of the invention, the optical system comprises a collimator configured to narrow the output beam.

In a preferred embodiment of the invention, the optical system comprises a polariser configured to polarise the beam of incident radiation received by the optical system.

In some embodiments of the invention the beam of incident radiation, the first and second split beams and the output beam all lie substantially in a plane. In one embodiment the plane is substantially horizontal while in another embodiment the plane is substantially vertical.

In an alternative embodiment, the spatial chirp unit is configured to spatially chirp the beam of incident radiation in a first plane and the first and second split beams form an angle in a second plane where the first and second split beams are incident on the optical mixing unit, the first plane being perpendicular to the second plane. More preferably, the first plane is substantially horizontal and the second plane is substantially vertical.

Preferably, the optical system is configured to receive a beam of incident radiation in the form of laser radiation, for example a pulse of laser radiation.

According to another aspect of the invention there is provided a spectrometer comprising a narrow bandwidth beam generator for narrowing the bandwidth of a beam of incident radiation, the narrow bandwidth beam generator comprising an optical mixing unit configured to receive a first beam of radiation and a second beam of radiation, wherein the first and second beams are spatially chirped and the first beam is inverted relative to the second beam, and wherein the optical mixing unit comprises an optical mixing member comprising a nonlinear optical medium to mix the first and second beams into an output beam having a narrower bandwidth than the beam of incident radiation.

Preferably, the spectrometer comprises an inversion unit configured to invert the first beam relative to the second beam prior to the beams being received by the optical mixing unit.

Preferably, the spectrometer comprises at least one spatial chirp unit configured to spatially chirp the incident radiation prior to inversion of the first beam relative to the second beam.

Preferably, the spectrometer comprises a splitter unit configured to split the incident radiation into the first and second beams.

According to another aspect of the invention there is provided a method of controlling the narrowing of the bandwidth of a beam of incident radiation in an optical system comprising an optical mixing unit configured to receive a first beam of radiation and a second beam of radiation, wherein the first and second beams are spatially chirped and the first beam is inverted relative to the second beam, and wherein the optical mixing unit comprises an optical mixing member comprising a nonlinear optical medium to mix the first and second beams into an output beam having a narrower bandwidth than the beam of incident radiation, and wherein the method comprises adjusting a path length of the first beam relative to the second beam.

Preferably, the optical system further comprises one or more reflecting members configured to reflect one of the first and second beams and the step of adjusting the path length of the first beam relative to the second beam comprises controlling the position and/or orientation of any one or more of the reflecting members. More preferably, the step of adjusting the path length of the first beam relative to the second beam comprises controlling the position of one of the reflecting members.

According to another aspect of the invention there is provided a method of controlling the narrowing of the bandwidth of a beam of incident radiation in an optical system comprising an optical mixing unit configured to receive a first beam of radiation and a second beam of radiation, wherein the first and second beams are spatially chirped and the first beam is inverted relative to the second beam, and wherein the optical mixing unit comprises an optical mixing member comprising a nonlinear optical medium to mix the first and second beams into an output beam having a narrower bandwidth than the beam of incident radiation, and wherein the method comprises adjusting an amount of spatial overlap of the first beam and the second beam.

Preferably, the optical system further comprises one or more reflecting members configured to reflect one of the first and second beams and the step of adjusting the amount of spatial overlap of the first beam and the second beam comprises controlling the position and/or orientation of any one or more of the reflecting members. More preferably, the step of adjusting the amount of spatial overlap of the first beam and the second beam comprises controlling the orientation of one of the reflecting members.

According to another aspect of the invention there is provided a method of controlling the narrowing of the bandwidth of a beam of incident radiation in an optical system comprising an optical mixing unit configured to receive a first beam of radiation and a second beam of radiation, wherein the first and second beams are spatially chirped and the first beam is inverted relative to the second beam and wherein the optical mixing unit comprises an optical mixing member comprising a nonlinear optical medium to mix the first and second beams into an output beam having a narrower bandwidth than the beam of incident radiation, and wherein the method comprises adjusting an orientation of the optical mixing unit to substantially phase match the first, second and output beams.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings:

FIG. 1 is a schematic illustration of sum-frequency mixing of spatially chirped pulses according to an embodiment of the invention.

FIG. 2 is a functional illustration of an optical system for narrowing the bandwidth of a beam of incident radiation, or bandwidth compressor, according to one embodiment of the invention.

FIG. 3 is a plan view schematic illustration of an optical system for narrowing the bandwidth of a beam of incident radiation, or bandwidth compressor, according to another embodiment of the invention.

FIG. 4 is a side view schematic illustration of the optical layout of the optical system of FIG. 3.

FIG. 5 is a schematic illustration of an optical system according to another embodiment of the invention;

FIG. 6 shows the spectra of the signal generated using an optical system according to the embodiments of FIG. 3 and FIG. 5.

FIG. 7 shows temporal traces of the signal generated using an optical system according to the embodiments of FIG. 3 and FIG. 5.

FIG. 8 shows fine tuning capability of an optical system according to one embodiment of the invention.

FIG. 9 shows broad tuning capability of an optical system according to one embodiment of the invention.

FIG. 10 is a schematic illustration of an optical system for narrowing the bandwidth of a beam of incident radiation, or bandwidth compressor, according to another embodiment of the invention.

FIG. 11 is a plan view illustration of part of an optical system for spectral bandwidth compression according to another embodiment of the invention.

FIG. 12 is a side view illustration of the part of an optical system shown in FIG. 11.

FIG. 13 is a functional illustration of an optical system for narrowing the bandwidth of a beam of incident radiation, or bandwidth compressor, according to another embodiment of the invention.

FIG. 14 is a plan view illustration of part of an optical system for spectral bandwidth compression according to another embodiment of the invention.

FIG. 15 is a side view illustration of the part of an optical system shown in FIG. 14.

FIG. 16 is a is a schematic illustration of a femtosecond simulated Raman spectroscopy system utilising an optical system for spectral bandwidth compression according to an embodiment of the present invention.

FIG. 17 shows normalised stimulated Raman spectra for (a) methanol and (b) acetone liquids generated using the FSRS system illustrated in FIG. 16.

### DETAILED DESCRIPTION OF PREFERRED EMBODIMENTS OF THE INVENTION

### Sum Frequency Mixing of Spatially Chirped Pulses

Nonlinear frequency conversion is a phenomenon whereby two photons of frequencies ω₁ and ω₂ and wave vectors k₁ and k₂, respectively, propagate together in a suitably configured nonlinear medium, and produce a photon at the sum-frequency of their combined energies ω₃=ω₂+ω₁. Sum-frequency generation (SFG) phase matching may be achieved by rotation of the nonlinear crystal so that the condition k₃=k₂+k₁ is satisfied. In a particular case of SFG, where photons of differing energies symmetric about a central frequency ω_{FF} by amount ±Δω can combine together to generate signal photons at a constant second harmonic frequency ω_{SH}=(ω_{FF}+Δω)+(ω_{FF}−Δω)=2ω_{FF}.

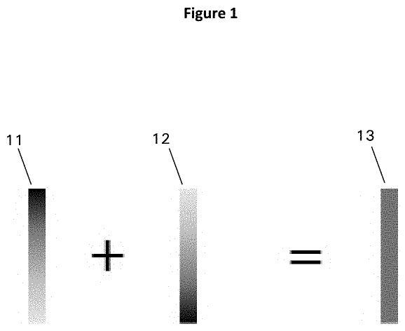

FIG. 1 is a schematic illustration of how the embodiments of the present invention described below take advantage of this phenomenon. A spatially chirped laser pulse or beam 11 is mixed in the frequency domain with a laser pulse or beam 12 with equal and opposite spatial chirp about a central frequency ω_{FF} to produce a monochromatic narrowband pulse or beam 13. Spectral components of equal energies ±Δω from the central frequency are monochromatic and phase matched for SFG at the fundamental frequency ω_{FF}.

The compressed signal bandwidth Δλ [symbol] ^{FWHM} is proportional to the spectral resolution of the fundamental pulses at the Fourier plane δλ_{FF} determined by the geometric configuration of the system, input wavelength and choice of dispersive member, and may be predicted as:

$$Δλ \text{?} \approx \frac{1}{4} {δλ}_{FF} = \frac{1}{4} ( {δλ}_{FF} + δλ \text{?} ) \\ \text{?} \text{indicates text missing or illegible when filed} \qquad ( 1 )$$

where δλ_{FP} is the spectral resolution of each colour in the Fourier plane determined by the focused Gaussian beam waist Δx₀, and linear dispersion in the focal plane ∂λ/∂x, where:

$${Δλ}_{FF} = Δ {x}_{0} \frac{\partial λ}{\partial x} \qquad ( 2 )$$

and Δλ_{D} is a distortion factor due to imperfect mixing of colours caused by the non-collinear crossing geometry of input beam angle α in the non-linear crystal of length L, where:

$${Δλ}_{D} = L tan ( α ) \frac{\partial λ}{\partial x} \qquad ( 3 )$$

It can be shown that the bandwidth compression of some embodiments of the invention is dependent on the input wavelength λ_{FF}, input spectral bandwidth Δλ_{FF}, angular dispersion of the chosen dispersion element ∂λ/∂θ, lens focal length f, input beam diameter D, and non-linear crystal input angle α—which are all factors easily characterised.

Unless the context clearly requires otherwise, throughout the description and the claims, it will be understood that a “spatially chirped” beam of light radiation is a beam in which the frequency of the radiation varies monotonically with a spatial coordinate. An “angularly dispersed” beam of light radiation is a beam in which the frequency of the radiation varies monotonically with an angular coordinate. Angular dispersion of light may be used to create a spatially chirped beam, although not all spatially chirped beams are angularly dispersed, for example if a lens or the like is applied to the angularly dispersed beam to create parallel rays, the resulting beam will be spatially chirped but not angularly dispersed.

### Bandwidth Compressor—First Embodiment

The principle of bandwidth narrowing will first be described in broad, functional terms before specific configurations of bandwidth compressors according to particular embodiments are described.

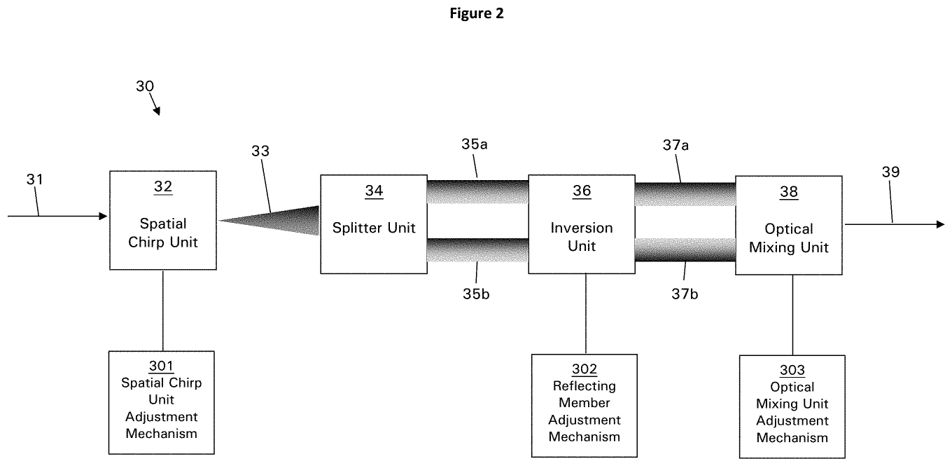

FIG. 2 is a functional illustration of an optical system 30 for narrowing the bandwidth of a beam of incident radiation, or bandwidth compressor, according to one embodiment of the invention.

Optical system 30, and optical systems according to other embodiments of the invention, comprises a plurality of units. Each unit may be formed from a single component or member, or each unit may be formed from a plurality of components or members that operate together to perform a function. The components of each unit may be coupled together or they may be separate. Any given component may form part of more than one unit, for example if that component performs or contributes to multiple functions.

Optical system 30 receives a beam 31, or pulse, of incident radiation. The beam 31 may be any form of electromagnetic radiation but in typical implementations of the invention the beam 31 will take the form of a pulse of laser light. In one embodiment of the invention, beam 31 comprises a broadband femtosecond laser pulse. A specific example is discussed below but in other examples of embodiments of the invention the pulse width may be less than 1 ps, for example around 50-100 fs.

Beam 31 is received by spatial chirp unit 32. Spatial chirp unit 32 is configured to receive beam 31 and to spatially chirp beam 31 to produce spatially chirped beam 33. Spatially chirping beam 31 may comprise angularly dispersing the beam. In some embodiments the spatial chirp unit comprises a dispersion grating, for example a transmissive grating, concave grating (which may also act as a focussing member), blazed reflective grating or other type of reflective grating. In other embodiments the spatial chirp unit comprises a dispersive prism, for example a dense flint prism or other type of prism. In other embodiments the spatial chirp unit comprises any optical member that imparts spatial chirp or angular dispersion on incident radiation. The spatial chirp unit 32 may comprise multiple dispersion members, including dispersion members of different types.

Spatially chirped beam 33 is received by splitter unit 34. Splitter unit 34 is configured to split beam 33 into first and second split beams 35a and 35b. Each of the split beams 35a and 35b is spatially chirped. In one embodiment of the invention, splitter unit 34 comprises a beam splitter. In another embodiment splitter unit 34 comprises a dispersion grating configured to split a beam of incident radiation. In one embodiment a dispersion grating both spatially chirps and splits a beam of incident radiation, in which case it will be understood that this dispersion grating forms part of both spatial chirp unit 32 and splitter unit 34. It will be understood that, in such an embodiment, beam 33 may not exist as a separate beam of radiation in the manner shown in FIG. 2.

In some embodiments of the invention, the positions of splitter unit 34 and the spatial chirp unit 32 may be swapped in the functional layout shown in FIG. 2, i.e. the beam 31 is received first by the splitter unit 34, which produces split beams, and each of the split beams is spatially chirped by spatial chirp unit 32.

Split beams 35a and 35b are received by inversion unit 36 that is configured to invert one of the beams relative to the other beam to produce split beam 37a and inverted split beam 37b. The inversion unit 36 may comprise optical members that act on one or both of the split beams 35a and 35b but the overall effect of inversion unit 36 is to invert one beam relative to the other beam. The inversion unit 36 may comprise a beam splitter and/or one or more reflecting members, for example mirrors, in the path of beam 37a or beam 37b. In one embodiment a dispersion grating performs all the functions of: spatially chirping the beam, splitting the beam and inverting one of the beams, in which case it will be understood that this dispersion grating forms part of spatial chirp unit 32, splitter unit 34 and inversion unit 36. It will be understood that, in such an embodiment, beams 33, 35a and 35b may not exist as separate beams of radiation in the manner shown in FIG. 2.

Split beams 37a and 37b are received by an optical mixing unit 38 that is configured to mix the beams and produce an output beam 39. Optical mixing unit 38 comprises one or more optical mixing members. The optical mixing members may comprise a nonlinear optical medium, for example a nonlinear optical crystal. In one embodiment the optical mixing member is a β-barium borate (BBO) crystal. The optical mixing member may alternatively (or additionally) comprise another second-order nonlinear crystal, for example bismuth borate (BiBO), lithium triborate (LBO), lithium niobate (LiNbO₃), monopotassium phosphate (KDP) or potassium titanyl phosphate (KTP) crystals.

Optical mixing unit 38 may also comprise one or more focussing members, or transforming members, configured to focus split beams 37a and 37b. For example, one or more lenses may be configured and arranged to focus split beams 37a and 37b onto a nonlinear optical crystal. Focussing members that may be used alone or combination in different embodiments of the invention include: convex lens (achromatic doublet), non-achromatic lens, concave mirror, and concave grating (which may also act as the spatial chip unit). An achromatic lens may present an advantage in some embodiments of the invention since this improves focussing of the colours on the same focal plane in a given range of wavelengths compared to a non-achromatic lens. Alternatively, one or more focussing members may be comprised as part of the spatial chirp unit 32.

Compared to input beam 31, output beam 39 is spectrally compressed, or more narrowband, as a result of sum-frequency generation phase matching of the split beams and output beam 39. In one example, a narrowband picosecond laser pulse is produced from a broadband femtosecond laser pulse.

It will be understood that, although different sections of the beams of radiation have been allocated different reference numbers in the above description and accompanying diagrams, some of these beams may be considered, in some contexts, to be the same beam that is manipulated between each section. For example, beam 37b may be considered to be the same beam as beam 35b, just an inverted form of that beam.

As will be described in more detail in relation to particular embodiments of the invention later, tuning of the optical system 30, for example to tune the frequency of output beam 39, may be achieved by adjustment to the orientation and/or position of parts of the optical system 30. To this effect, optical system 30 may comprise one or more adjustment mechanisms and associated control systems, for example spatial chirp unit adjustment mechanism 301 configured to adjust the orientation and/or position of the spatial chirp unit or part thereof, reflecting member adjustment mechanism 302 configured to adjust the orientation and/or position of one or more reflecting members, and optical mixing unit adjustment mechanism 303 configured to adjust the orientation and/or position of an optical mixing unit or part thereof. In some embodiments, the adjustment of one or more components in the optical system causes the optical path length of one of the split beams 35a, 35b, 37a or 37b to be adjusted (i.e. shortened or lengthened) relative to the other split beam, thus enabling tuning of the optical system 30 by allow path length adjustment, for example path length matching to enhance temporal overlap of the split beams. The adjustment mechanisms are operably connected to the respective components in a manner that allows manual or automatic adjustment of their orientation and/or position.

Optical system 30 may comprise a phase matching mechanism configured to substantially phase match the first and second split beams and the output beam to facilitate sub-frequency mixing. The phase matching mechanism may allow a phase matching condition for nonlinear conversions such as sum frequency generation to occur. In one embodiment the phase matching mechanism comprises the optical mixing unit adjustment mechanism 303. For example, phase matching may be achieved by rotation of a nonlinear optical crystal in which the split beams are mixed. In one embodiment, to achieve phase matching, the crystal may be rotated around an axis orthogonal to an axis around which the angle of light incident on the spatial chirp unit may vary. Alternatively, the phase matching mechanism may comprise a mechanism configured to adjust a field parameter applied to one or more of the split beams, for example the mechanism may be configured to adjust an electric field, a temperature or a pressure of, or applied to, one or more of the split beams.

Optical system 30 achieves spectral bandwidth compression allowing fine and broad tunability in a relatively simple configuration of components with relatively high efficiency. Additional or alternative advantages of particular embodiments of the invention will be described in the ensuing description.

In one embodiment, the invention comprises an optical system or optical device configured to receive two spatially chirped beams where one beam is inverted relative to the other beam. That is, the spatial chirping, splitting and inverting of the incident radiation may occur in a separate system. In other embodiments, the optical system optionally includes any one or more of the inversion unit, spatial chirp unit and splitter unit, with the other units being incorporated into a device acting on the radiation prior to being received by the optical system of an embodiment of the invention.

### Bandwidth Compressor—Second Embodiment

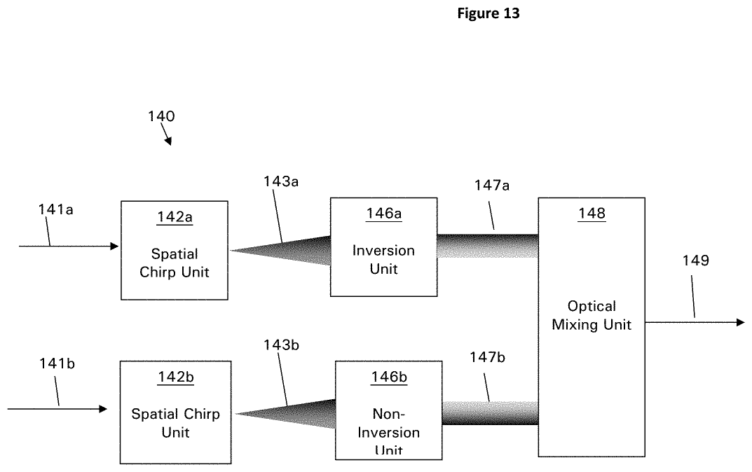

FIG. 13 is a functional illustration of an optical system 140 for narrowing the bandwidth of a beam of incident radiation, or bandwidth compressor, according to another embodiment of the invention.

Optical system 140 comprises an optical mixing unit 148 that is configured to mix beams of radiation 147a and 147b to produce output beam 149 in a similar manner to that described above in relation to optical mixing unit 38. Beams 147a and 147b are spatially chirped with beam 147a being inverted relative to beam 147b so that optical mixing unit 148 sum-frequency mixes the beams.

Beams 147a and 147b may be produced from beams 143a and 143b that are not inverted relative to each other by inversion unit 146a acting on beam 143a to invert the beam relative to beam 143b to produce inverted beam 147a. At the same time, beam 143b may pass through ‘non-inversion’ unit 146b. Non-inversion unit 146b may comprise one or more optical members that do not invert beam 143b but present substantially the same optical path length as inversion unit 146a. In some embodiments, non-inversion unit 146b is not present. In one embodiment, inversion unit 146a and non-inversion unit 146b represent different paths through a single device or sub-assembly.

Beams 143a and 143b are spatially chirped from incident radiation by spatial chirp units 142a and 142b. Spatial chirp units 142a and 142b may be separate components that produce spatial chirp, for example dispersion gratings, or they may be different parts of a single component producing spatial chirp with the incident beams 141a and 141b incident on different parts of said component.

In some embodiments, incident beams 141a and 141b are received from separate light sources. In other embodiments, incident beams 141a and 141b are produced by splitting light from a single source, for example using a splitter unit as explained in relation to FIG. 2.

### Bandwidth Compressor—Third Embodiment

Particular configurations of bandwidth compression systems according to embodiments of the invention will now be described. It should be understood that, where a component is described in relation to one embodiment, that component may be replaced with another component of equivalent or similar function, for example as described herein in relation to another embodiment of the invention, even if not explicitly stated.

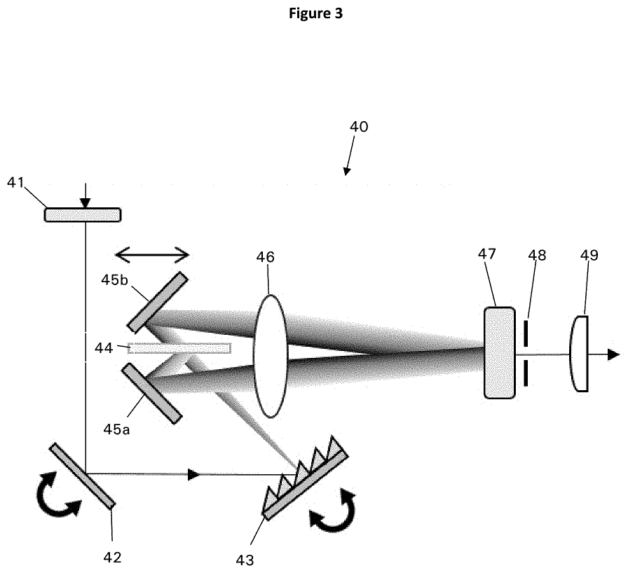

FIG. 3 is a plan view schematic illustration of an optical system 40 for narrowing the bandwidth of a beam of incident radiation, or bandwidth compressor, according to another embodiment of the invention.

In optical system 40, the input beam is received by a polariser 41 configured to polarise the input beam. Polariser 41 may comprise a half wave-plate or any other polarising member or assembly of polarising members. The polariser 41 is not present in all embodiments, although where it is present it may improve the efficiency of the system, e.g. if transmission through/reflection off the spatial chirp unit are dependent on the polarisation.

The polarised beam is directed towards dispersion grating 43 by a mirror 42. A mirror adjustment mechanism allows the orientation of mirror 42 to be adjusted to broadly tune the optical system 40. In the configuration shown in FIG. 3, the beam is incident on dispersion grating 43 in a direction approximately perpendicular to the direction the beam travels between polariser 41 and mirror 42 and at an oblique angle. A dispersion grating adjustment mechanism allows the orientation of dispersion grating 43 to be adjusted. Such an adjustment may be made, for example based on changes to the frequency of the input beam, since the angle of dispersion of light be the dispersion grating 43 is dependent on the frequency of the light.

Dispersion grating 43 spatially chirps/angularly disperses the light beam. The spatially chirped beam is obliquely incident on a beam splitter 44, which results in two split beams of spatially chirped radiation (by reflecting part of the incident radiation to create one beam and transmitting part of the incident radiation to create the other beam). Optical system 40 comprises two mirrors 45a and 45b positioned either side of beam splitter 44 such that the split beam resulting from reflection in the beam splitter 44 is obliquely incident on a mirror 45a and the split beam resulting from transmission through beam splitter 44 is obliquely incident on mirror 45b. Mirrors 45a and 45b each reflect one of the split beams and are angled such that the split beams are directed in an approximately parallel direction. In the configuration shown in the embodiment of FIG. 3, this direction is approximately parallel to the direction in which the light travels from mirror 42 to dispersion grating 43. The overall effect of the beam splitter 44 and mirrors 45a and 45b is to create two approximately parallel split beams of spatially chirped light with one beam inverted relatively to the other, i.e. the two beams are oppositely chirped—one beam is negatively chirped and the other is positively chirped.

A mirror adjustment mechanism allows the orientation and/or position of mirror 45b to be adjusted. In an alternative embodiment there is provided a mirror adjustment mechanism that allows the orientation and/or position of mirror 45a to be adjusted. In the embodiment shown in FIG. 3, mirror 45b may be rotated to adjust the degree of spatial overlap of the focussed spatially chirped split beams in the axis of the crystal 47 perpendicular to the optical axis of the focussing lens 46. Mirror 45b may also be moved forwards and backwards along the optical axis of focussing lens 46 using a delay stage to allow path length matching between the split beams to enhance temporal overlap.

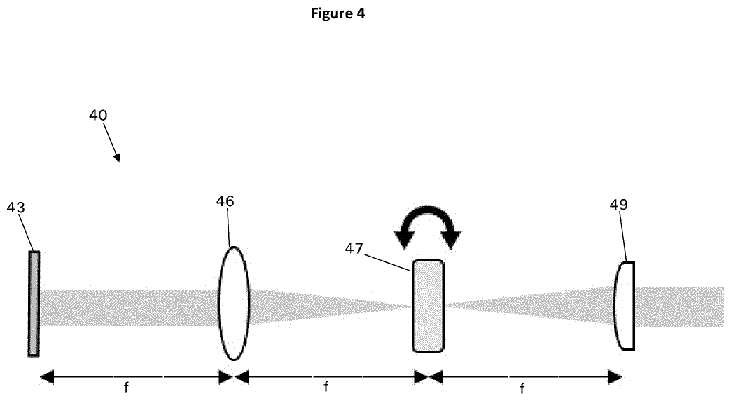

Focussing lens 46 is positioned in the path of the split beams of spatially chirped light. A nonlinear optical crystal 47, such as a BBO crystal, is positioned in the focal plane of the focussing lens 46. The split beams are mixed in the crystal 47 to create a spectrally compressed output beam. A crystal adjustment mechanism allows the orientation and/or position of crystal 47 to be adjusted. In the embodiment shown the crystal adjustment mechanism rotates the crystal 47 about the optical axis for phase matching when broad tuning the optical system 40 to accommodate different input wavelengths. In one embodiment the angle of crystal 47 is adjusted in combination with, or as a result of, adjustments made to the angle of mirror 42 in order to ensure phase matching. In the experimental configuration of FIGS. 3 and 4, crystal 47 is rotated around an orthogonal axis to the direction in which mirror 42 is rotated to achieve phase matching.

The output beam may be passed through an iris 48 and collimator 49 that narrows the output beam. Iris 48 may be present in some embodiments of the invention. If present, it blocks the two residual fundamental beams that continue to propagate in the non-collinear direction, while the signal propagates straight along the optical axis due to conservation of momentum. This is an advantage of a non-collinear geometry in that makes spatially blocking of the residuals more convenient (compared to using a filter in a collinear geometry).

FIG. 4 is side view a schematic illustration of the optical layout of the optical system 40 of FIG. 3. FIG. 4 illustrates the ‘2f’ configuration of dispersion grating 43, focussing lens 46 and crystal 47, i.e. dispersion grating 43 and crystal 47 are in the focal plane of, and on either side of, the focussing lens 46, e.g. the dispersion grating 43 and crystal 47 are positioned a focal length away from focussing lens 46 along the optical axis of the lens 46 and on either side of the lens 46. Collimator 49 may be a lens having a focal length substantially equal to that of the focussing lens 46 and positioned such that it is positioned on the other side of crystal 47 from focussing lens 46 with crystal 47 in its focal plane.

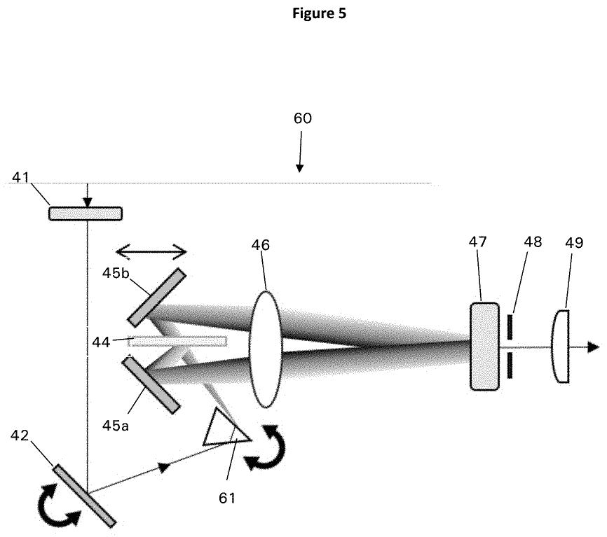

FIG. 5 is a schematic illustration of an optical system 60 according to another embodiment of the invention. Optical system 60 is similar to optical system 40 shown in FIG. 3 but with a dispersive prism 61 in place of dispersion grating 43. Dispersive prism 61 is configured to have its orientation and/or position adjusted by a suitable adjustment mechanism.

In experimental tests using a configuration as shown in FIGS. 3, 4 and 5 a type 1 BBO crystal of thickness L=0.5 mm cut for second-harmonic generation (SHG) at wavelength λ_{FF}=800 nm was used, generated from a 3 kHz Ti:Sapphire regenerative amplifier producing pulses with spectral bandwidth Δλ [symbol] ^{FWHM}=10.6 nm.

In a first set of experiments, a dense flint H-ZF62 prism with angular dispersion of 6.7 nm/mrad (input at Brewster's angle) was chosen as the dispersive prism 61 in the configuration shown in FIG. 5 and, in a second set of experiments, a 1200 gr/mm diffraction grating blazed for 750 nm with a higher angular dispersion of 0.82 nm/mrad (as calculated for input angle 0.95 rad) was used as the dispersion grating 43 in the configuration shown in FIG. 3. The input fundamental pulse energy was attenuated to 12.7 μJ and polarisation of the input beam was tuned with a half wave-plate for maximum efficiency at the dispersion member. Following dispersion, the fundamental pulse was split into two copies with a beam splitter, and two mirrors inversed one pulse with respect to the other, producing two pulses with equal and opposite spatial chirp. An achromatic doublet (Thorlabs AC508-250-A-ML) of focal length f=250 mm was used as the focussing lens 46 to focus the two chirped pulses to the Fourier plane as overlapping strips of length X=2f·tan ξ, where ξ is the dispersion cone angle calculated from input angle α to the dispersive element using Snell's law n₁ sin α=n₂ sin β and the grating equation sin α+sin β=10⁻⁶ kgλ for the dispersive prism 61 and dispersion grating 43, respectively.

The two beams were mixed in a non-collinear geometry in the BBO crystal 47 with an input angle of 0.07 rad between them, allowing separation of the signal and fundamental beams with an iris 48 placed a distance after the BBO crystal 47. Phase matching of the SFG conversion was increased, while SHG conversion of the individual pulses reduced by rotating the BBO crystal 47.

Enhancement of the spatial and temporal overlap of the chirped pulses in the Fourier plane is achieved by fine adjustment of a single optical element, mirror 45b. As described above, rotation of the mirror 45b spatially overlaps the focussed split beams in the perpendicular axis of the BBO crystal 47, while translation of mirror 45b along the optical axis of lens 46 using a delay stage allows path length matching to improve temporal overlap.

A cylindrical lens 49 of focal length f=250 mm is placed a distance f away from the BBO crystal 47 to collimate the signal beam.

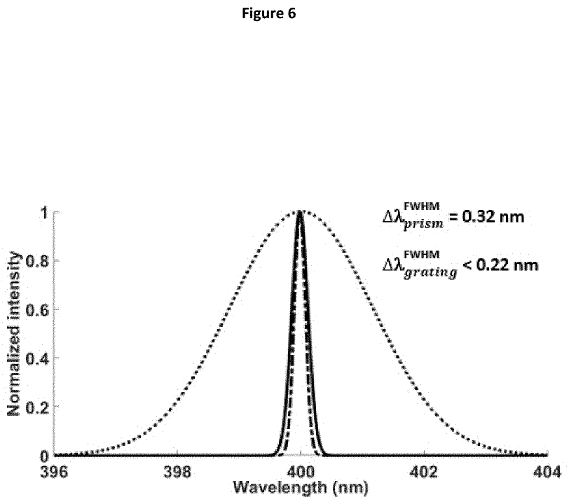

To characterise the spectra of the signal pulse in experimental testing, a high-resolution (OR=0.2 nm) fiber-coupled spectrograph (Brolight BIM-6602-02) recorded the pulse spectra. FIG. 6 shows the spectra of the signal generated using an H-ZF64 prism as the dispersive prism 61 in the configuration of FIG. 5 (solid line in FIG. 6), and was measured to have a spectral bandwidth Δλ^{FWHM} of 0.32 nm (20.0 cm⁻¹) demonstrating a significant compression factor of approximately 9 compared to the fundamental input 400 nm pulse (dash line in FIG. 6), with a measured Δλ^{FWHM} of 11 nm (171.9 cm⁻¹). This result is close to the predicted spectral bandwidth of Δλ^{FWHM}≈0.38 nm (23.8 cm⁻¹) determined by equation (1). As a useful measure of bandwidth compression, comparison to the second harmonic pulse generated using the same BBO, but without the use of the compressor, was recorded as Δλ^{FWHM} of 2.73 nm (170.6 cm⁻¹) on the same spectrograph.

Replacing the prism with a higher dispersing 1200 gr/mm diffraction grating for the dispersion grating 43 in the configuration of FIG. 3, further spectral compression of a factor of approximately 12 was achieved, with a bandwidth of Δλ^{FWHM} of <0.22 nm (13.8 cm⁻¹) recorded at the optical resolution (OR) limit of the spectrograph (dash-dot line in FIG. 6).

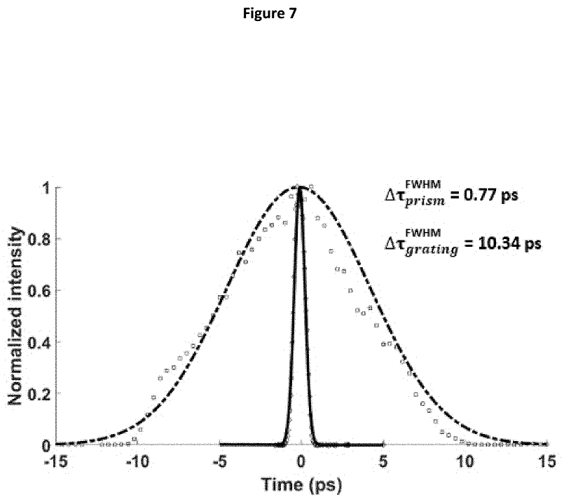

The temporal profile of the signal was characterised using Transient-Grating Frequency-Resolved Optical Gating (TG-FROG) (J. N. Sweetser, D. N. Fittinghoff and R. Trebino, Opt. Lett. 22 No. 8, (1996) and K. Chen, J. Gallaher, A. Barker and J, Hodgkiss, J. Phys. Chem. Lett., 5(10) (2014)). The results in FIG. 7 show a Gaussian shaped profile with a temporal envelope Δτ^{FWHM}=0.77 ps using the prism dispersive member 61 of FIG. 5 corresponding to a time expansion factor of approximately 8 (solid line in FIG. 7), and a temporal envelope of Δτ^{FWHM}=10.34 ps using the dispersion grating of FIG. 3 giving an expansion factor of approximately 129 (dash-dot line in FIG. 7). Assuming transform limited pulses, predicted spectral bandwidths can be derived from the time bandwidth product (TBP) for a Gaussian profile ΔvΔτ=0.44. Applying this to the unresolved spectral bandwidth of the 400 nm harmonic pulse using the dispersion grating 43 the inventors predict an actual spectral bandwidth of approximately 0.02 nm (1.25 cm⁻¹), which also agrees with the spectral bandwidth predicted by equation (1). The spatial profile of the signal beam is divergent along one axis (perpendicular), and collimated along the other (parallel) with a collimated width proportionate to the focused strip width, X. Choosing a cylindrical lens 49 of a suitable focal power placed after the iris 48, the beam may be collimated or telescoped into a usable beam for application.

To compare spectral bandwidth achieved by optical systems 40 and 60 with other temporal-domain bandwidth compressors generating pulses at differing central frequencies, it is useful to use the central wavelength independent unit of wavenumbers. Picosecond pulses produced in experiments by optical systems 40 and 60 have a best measured bandwidth of 13.8 cm⁻¹ at the OR limit of the spectrograph used, and a predicted bandwidth of 1.25 cm⁻¹ based on equation (1) and the measured temporal pulse width. This bandwidth is comparable or better than prior systems with reported bandwidths of 8.5 cm⁻¹ to 93 cm⁻¹ (M. Marangoui, D. Brida, M, Quintavalle, G. Cirmi, F. M. Pigozzo, C. Manzoni, F. Baranio, A. D Capobianco and G. Cerullo, Opt. Exp. Vol (15), No 14, 8884 (2007); F. Raoult, A. C. L. Boscheron, D. Husson, and C. Sauteret, Opt. Lett. Vol 23 No. 14 (1998); H. Luo, L. Qian, P. Yuan, and H. Zhu, Opt. Exp. Vol 14 No. 22, 10631 (2006)).

Power throughput was measured at the optical system input, immediately before the BBO crystal 47 and immediately after the BBO crystal 47. The fundamental input beam was first attenuated to a pulse energy of 12.7 μJ using a variable neutral density filter at the system input, and the combined energy of the two pulses measured immediately before the BBO crystal 47 to be 10.1 μJ at the input to the BBO crystal 47, with the narrowband signal output having a power of 1.9 μJ demonstrating an 18.8% conversion efficiency for the SFG process and an overall system efficiency of 14%. Comparison with temporal-domain bandwidth compressors shows this conversion efficiency is acceptable, with other compressors reporting efficiencies in the range of 0.5%-40% (G. Xu, L. Qian, T. Wang, H. Zhu, C. Zhu and D. F, IEEE J. Quant. Elect. (10) (2004); F. Raoult, A. C. L. Boscheron, D. Husson, and C. Sauteret, Opt. Lett. Vol 23 No. 14 (1998); S. A. Kovalenko, A. L Dobryakov, N. P. Ernsting, Rev Sci Instrum. Vol (6), 82(6):063102 (2011)). Energy losses close to 20% throughout the optical systems 40 and 60 may occur due to transmission losses through the prism and reflection losses at the mirrors. SFG efficiency saturation was not achieved using dispersion grating 43, due to both higher power losses using a grating blazed for a Littrow geometry in a grazing input angle geometry, and significantly lower power density at the BBO crystal 47 due to the wider strip length caused by higher angular dispersion.

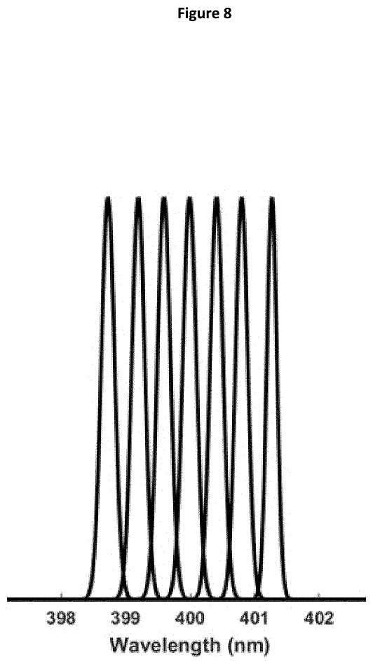

Of relevance to spectroscopic applications is the ability to produce tunable narrowband picosecond pulses across a wide spectral range. Temporal domain compressor systems typically report broad tunability using a variety of system adjustments, with tuning ranges limited to some range about the fundamental system output with tuning ranges of 720 nm to 890 nm and 1000 nm to 1090 nm, depending on the laser source (M. Marangoui, D. Brida, M, Quintavalle, G. Cirmi, F. M. Pigozzo, C. Manzoni, F. Baranio, A. D Capobianco and G. Cerullo, Opt. Exp. Vol (15), No 14, 8884 (2007); H. Luo, L. Qian, P. Yuan, and H. Zhu, Opt. Exp. Vol 14 No. 22, 10631 (2006)). In optical systems 40 and 60, fine-tuning of the output signal frequency λ_{SH} is conveniently achieved by translating one of the chirped strips with respect to the other in the plane of the BBO crystal 47 in order to adjust the central mixing frequency λ_{FF} by rotation of mirror 45b. FIG. 8 shows a tuning range of approximately 2.5 nm about a central frequency of 400 nm, albeit with a signal intensity decrease towards the edges of the tuning range. In some embodiments of the invention this signal loss may be compensated for by tuning the angle of dispersion grating 43 and/or re-configuring path length matching by positioning mirror 45b to maintain high conversion efficiency.

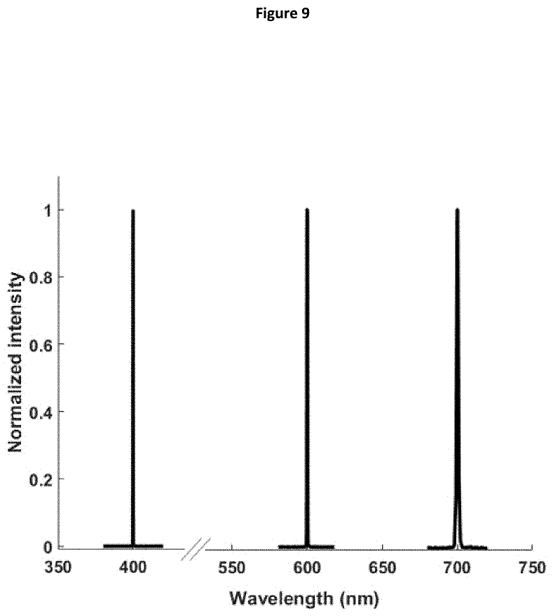

For broad tuning, an advantage of some embodiments of the invention is the use of a thin BBO crystal 47, which allows the phase matching condition for SFG to be satisfied across a wide spectrum of input wavelengths, by rotation of the crystal 47 vertically about the focal plane. This was demonstrated using the two different input wavelengths generated from a 800 nm fundamental pulse via conversion in a commercial Optical Parametric Amplifier (OPA) (Light Conversion TOPAS). FIG. 9 shows different SFG signal wavelengths generated by adjustment of the input angle to the dispersion grating 43, achieved by rotation of mirror 42, and rotation of the BBO crystal 47, to match the fundamental input frequency generating a narrowband pulse at central frequency 600 nm with Δλ^{FWHM} of <0.41 nm (11.4 cm⁻¹) from a 1200 nm input, recorded using a fiber-coupled spectrograph (Ocean Optics HR4000). Similarly a narrowband pulse with Δλ^{FWHM} of <1.3 nm (26.5 cm⁻¹) at central frequency 700 nm was generated from a 1400 nm fundamental input pulse, measuring at the limit of the low-resolution USB spectrometer used (OR 1.3 nm).

### Bandwidth Compressor—Fourth Embodiment

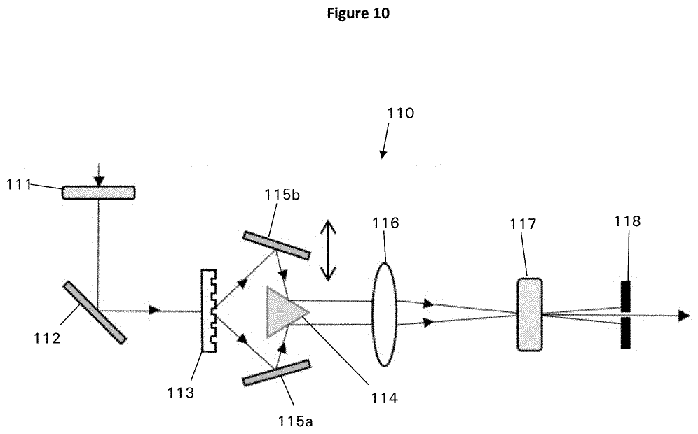

FIG. 10 is a schematic illustration of an optical system 110 for narrowing the bandwidth of a beam of incident radiation, or bandwidth compressor, according to another embodiment of the invention. Optical system 110 comprises a polariser 111, mirror 112, focussing lens 116, nonlinear optical crystal 117 and iris 118 that are similar to the equivalent components of optical systems 40 and 60. These components will not be described in further detail here but it is to be understood that any variations or modifications described in relation to these components in optical systems 40 and 60 also apply to the components in optical system 110.

Optical system 110 achieves the spatial chirp, splitting and inversion of the incident beam in a different manner to optical systems 40 and 60. In optical system 110 a transmissive grating 113 is positioned in the path of the incident beam and on the optical axis and in the focal plane of focussing lens 116. Transmissive grating 113 is configured to spatially chirp (e.g. through angularly dispersion) and split the incident beam into two split beams in the first order modes m=±1. The split beams are spatially chirped symmetrically so that one beam mirrors the other. That is, transmissive grating 113 also inverts one beam relative to the other. In terms of the functional layout of an optical system shown in FIG. 2, transmissive grating 113 is comprised in the spatial chirp unit 32, the splitter unit 34 and the inversion unit 36.

Mirrors 115a and 115b are positioned in the path of the spatially chirped split beams and are oriented to reflect the split beams towards prism mirror 114. Prism mirror 114 is configured and positioned to direct the beams towards focussing lens 116. In an alternative embodiment two or more mirrors may be used in place of prism mirror 114.

Tuning of optical system 110 may be achieved by adjusting the position and/or orientation of mirror 115a or 115b. For example, translation of mirror 115b along the optical axis of lens 116 using a delay stage allows path length matching to improve temporal overlap and rotation of mirror 115b fine-tunes the output signal frequency by translating one of the chirped strips with respect to the other in the plane of the crystal 117 in order to adjust the central mixing frequency λ_{FF}. Optical system 110 includes one or more mirror adjustment mechanisms and control systems to effect the adjustment of the position and/or orientation of mirror 115a or 115b.

Compared to optical systems 40 and 60 of FIGS. 3 and 5 respectively, optical system 110 improves efficiency at high dispersion, allowing narrower and/or more intense picosecond pulses to be generated.

### Bandwidth Compressor—Fifth Embodiment

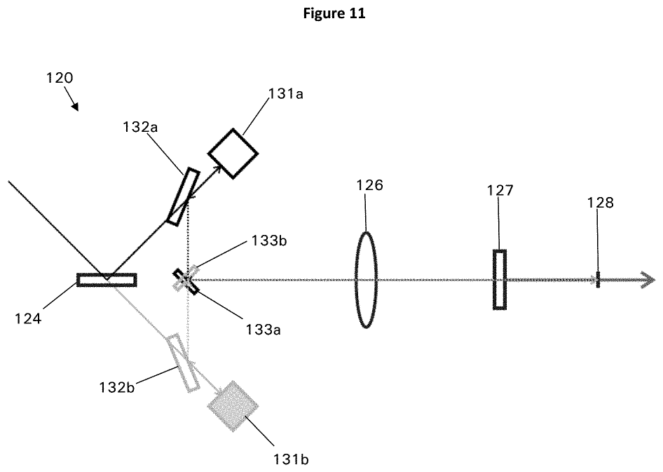

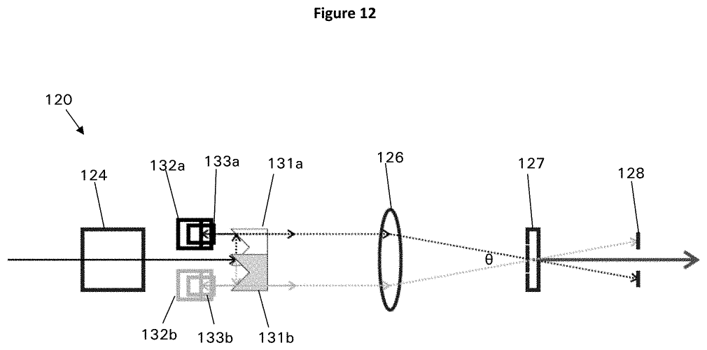

FIGS. 11 and 12 are plan and side view illustrations respectively of part of an optical system 120 for spectral bandwidth compression according to another embodiment of the invention. In another embodiment of the invention, optical system 120 may be in a different orientation to that shown in FIGS. 11 and 12, for example optical system 120 may be rotated through 90° so that FIG. 11 is a side view illustration of the optical system and FIG. 12 is a plan view illustration of the optical system.

Optical system 120 comprises a beam splitter 124, focussing lens 126, nonlinear optical crystal 127 and iris 128 that are similar to the equivalent components of optical systems 40, 60 and 110. These components will not be described in further detail here but it is to be understood that any variations or modifications described in relation to these components in optical systems 40, 60 and 110 also apply to the components in optical system 120.

Not shown in FIGS. 11 and 12 are a polariser, optional mirror and spatial chirp member that may act on the incident beam prior to being received by the components shown in FIGS. 11 and 12. That is, beam splitter 124 receives a spatially chirped beam of incident radiation. The spatial chirp member spatially chirps the beam so that the incident beam in FIGS. 11 and 12 is spatially chirped in the horizontal plane.

The spatially chirped beam is obliquely incident on beam splitter 124 and two split beams are produced. The optical system 120 is configured so that the reflected split beam is incident on a first out-of-plane reflection assembly 131a. Out-of-plane reflection assembly 131a has the effect of directing the reflected split beam from the plane of the incident beam to a different plane, e.g. a parallel but higher plane as can be seen in FIG. 12. Out-of-plane reflection assembly 131a may take the form of a plurality of mirrors and/or prisms positioned to achieve this effect, for example a roof mirror.

Mirror 132a is positioned such that the reflected split beam from out-of-plane reflection assembly 131a is reflected in mirror 132a and directed towards mirror 133a. Mirror 133a is positioned such that this split beam is reflected towards focussing lens 126.

The optical system 120 is configured so that the split beam produced by transmission of radiation through beam splitter 124 is incident on a second out-of-plane reflection assembly 131b. Out-of-plane reflection assembly 131b has the effect of directing the reflected split beam from the plane of the incident beam to a further different plane, e.g. a parallel but lower plane as can be seen in FIG. 12. Out-of-plane reflection assembly 131b may take the form of a plurality of mirrors and/or prisms positioned to achieve this effect, for example a roof mirror or other assembly of two mirrors positioned perpendicularly.

Mirror 132b is positioned such that the reflected split beam from out-of-plane reflection assembly 131b is reflected in mirror 132b and directed towards mirror 133b. Mirror 133b is positioned such that this split beam is reflected towards focussing lens 126.

It will be appreciated that, while two out-of-plane mirror assemblies 131a and 131b are used in the embodiment of FIGS. 11 and 12, in an alternative embodiment a single out-of-plane mirror assembly may be used to divert one of the split beams to a different plane. The optical system of such an embodiment may need to be configured such that the optical paths of each split beam is of the same length.

The effect of the assembly of mirrors that has been described in relation to FIGS. 11 and 12 is that the two split beams are incident on crystal 127 in a plane that is different to the spatial chirp plane. For example, in the illustrated embodiment, the incident beam is initially spatially chirped in the horizontal plane and the split beams incident on crystal 127 lie in, and form a crossing angle θ with respect to one another in, the vertical plane. This configuration may remove potential compression bandwidth limitations that occur when the spatial chirp and crossing angles are in the same plane due to geometrical smearing caused by large noncollinear incident angles to the crystal 127.

### Bandwidth Compressor—Sixth Embodiment

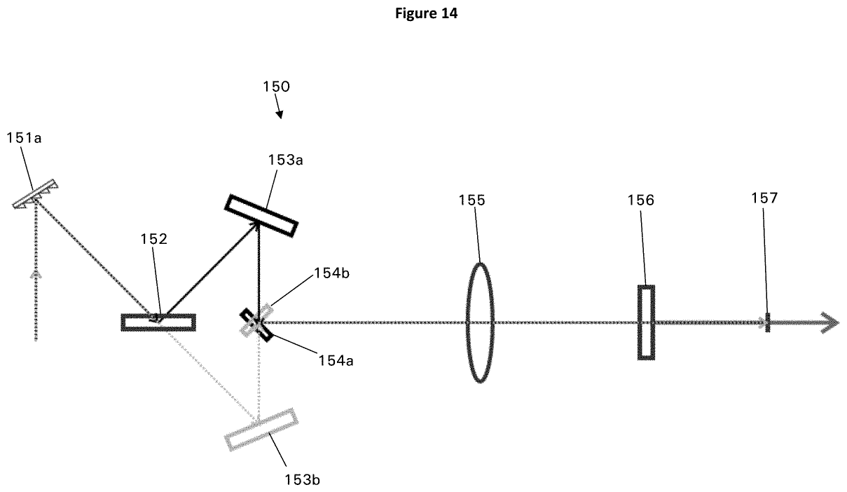

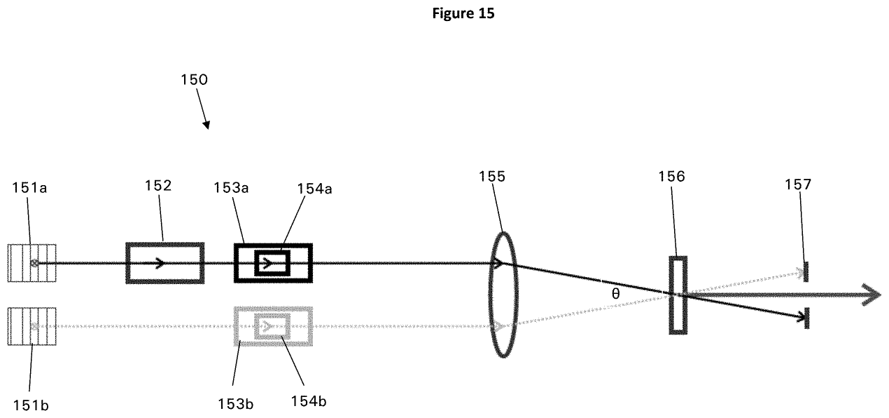

FIGS. 14 and 15 are plan and side view illustrations respectively of part of an optical system 150 for spectral bandwidth compression according to another embodiment of the invention. In another embodiment of the invention, optical system 150 may be in a different orientation to that shown in FIGS. 14 and 15, for example optical system 150 may be rotated through 90⁰ so that FIG. 14 is a side view illustration of the optical system and FIG. 15 is a plan view illustration of the optical system.

In the embodiment of FIGS. 14 and 15, light (e.g. laser pulses) is received from two different light sources (not shown) and dispersion gratings 151a and 151b are each positioned in the path of one of the beams from the light sources. In the embodiment shown the dispersion gratings 151a and 151b are positioned in the same orientation and position in the horizontal plane but with different positions in the vertical plane.

A mirror 152 is positioned in the path of one of the spatially chirped beams, i.e. the top beam spatially chirped by dispersion grating 151a in the embodiment shown in FIGS. 14 and 15. The bottom beam is allowed to pass under the mirror 152. Mirror 152 inverts the reflected beam relative to the non-reflected beam.

Mirrors 153a and 154a are positioned in the path of the top beam to direct the top beam towards focussing lens 155. Mirrors 153b and 154b are similarly positioned in the path of the bottom beam to direct the bottom beam towards focussing lens 155. The mirrors are configured so each beam has substantially the same optical path length.

Focussing lens 155 focuses the two beams on crystal 156 in a similar manner to that described in relation to other embodiments of the invention so that the two beams are mixed in the crystal 156 to produce an output beam. Iris 157 may also be provided.

In the embodiment of FIGS. 14 and 15 the beams are spatially chirped in the horizontal plane and the split beams incident on crystal 156 lie in, and form a crossing angle θ with respect to one another in, the vertical plane.

### Potential Applications

Potential applications of optical systems according to embodiments of the invention include any system in which a narrowband laser pulse, for example an intense narrowband picosecond laser pulse, is used. Examples include ultrafast laser applications where high spectral resolution is required, such as time-resolved vibrational pump-probe spectroscopy and sum-frequency generation (SFG) surface spectroscopy, Raman spectrometers, pulse generators, pulse converters and quantum information transfer systems. Such systems may include a narrowband beam generator in the form of any of the embodiments of the invention.

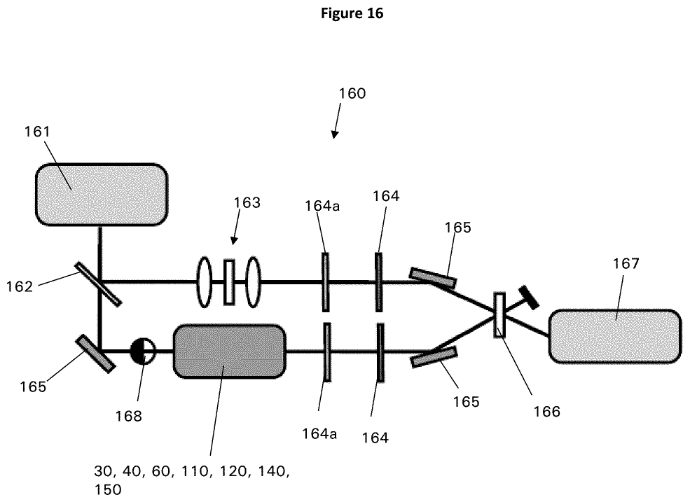

For example, FIG. 16 illustrates use of an embodiment of the present invention in femtosecond stimulated Raman spectroscopy (FSRS) in the steady state. In the illustrated FSRS system 160 a mode locked Ti:Sapphire amplifier 161 delivers 3 W 100 fs pulses at a central wavelength of 800 nm with a 3 kHz repetition rate. A beam splitter 162 sends a small portion of the pulse for supercontinuum generation 163 to generate the broadband probe. The remaining power is attenuated and sent to a bandwidth compressor 30, 40, 60, 110, 120, 140, 150 according to an embodiment of the present invention, for generation of the narrowband Raman pump. The probe and pump pulses are horizontally polarised by a polariser 164. Each polariser may comprise a half wave plate 164a or any other polarising member or assembly of polarising members. Both polarised pulses are focussed using mirrors 165 to overlap at the centre of a 1 mm cuvette 166 in a non-collinear geometry. The probe pulse is dispersed and collected on a home-built Czerny Turner transmission grating spectrometer 167 for data collection. The spectrometer has an OP of 20 cm⁻¹ across a spectral range of 3100 cm⁻¹. Spectra are collected on a CMOS detector array (Lightwise LW-ELIS-1024a-1394), at a readout rate of 3 kHz to capture each Raman pump on-off shot. A sequence of shots with the Raman pump on and Raman pump off is generated using a mechanical chopper 168 running at 1.5 kHz in the Raman pump line, allowing the Raman gain spectra to be extracted and normalized by division of the pump-off probe spectrum.

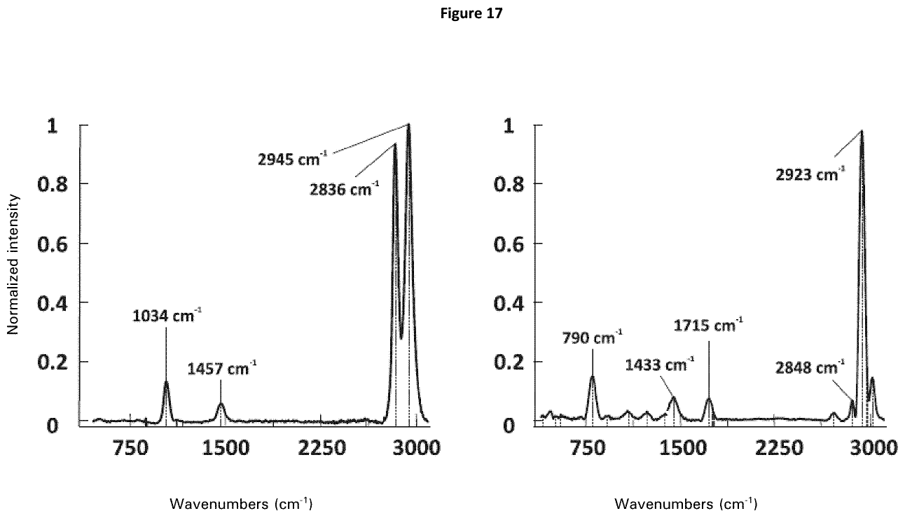

Using the set up illustrated in FIG. 16, stimulated Raman spectra were obtained for acetone and methanol with a Raman pump energy of 3.3 μJ. Data was averaged over 60,000 shots to obtain each spectrum. FIG. 17 shows the averaged spectra normalised for each liquid showing good agreement with the expected Raman peak positions obtained from spontaneous Raman spectroscopy data (LabRAM HR800). Baseline artefacts due to cross phase modulation of the pump and probe beams were removed using polynomial fit and subtraction computation. The FWHM bandwidth resolution of the measured spectra is approximately 30 cm⁻¹ demonstrating good performance of the Raman pump in comparison with other steady state FSRS systems.

Other applications will be apparent to those of skill in the art and embodiments of the invention are not limited to those applications specified herein.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. An optical system for narrowing the bandwidth of a beam of incident radiation, the optical system comprising an optical mixing unit configured to receive a first beam of radiation and a second beam of radiation, wherein the first and second beams are spatially chirped and the first beam is inverted relative to the second beam, and wherein the optical mixing unit comprises an optical mixing member comprising a nonlinear optical medium to mix the first and second beams into an output beam having a narrower bandwidth than the beam of incident radiation.

2-6. (canceled)

7. An optical system as claimed in claim 1, wherein the optical system comprises at least one spatial chirp unit configured to spatially chirp the incident radiation prior to inversion of the first beam relative to the second beam, and wherein the spatial chirp unit comprises a dispersion grating.

8. An optical system as claimed in claim 1, wherein the optical system comprises at least one spatial chirp unit configured to spatially chirp the incident radiation prior to inversion of the first beam relative to the second beam, and wherein the spatial chirp unit comprises a dispersive prism.

9. An optical system as claimed in claim 1, wherein the optical system comprises at least one spatial chirp unit configured to spatially chirp the incident radiation prior to inversion of the first beam relative to the second beam, and wherein the optical system comprises a spatial chirp unit adjustment mechanism configured to adjust the orientation and/or position of the spatial chirp unit or part thereof.

10. (canceled)

11. An optical system as claimed in claim 1, wherein the optical system comprises a splitter unit configured to split the incident radiation into the first and second beams, and wherein the splitter unit comprises a dispersion grating.

12. An optical system as claimed in claim 1, wherein the optical system comprises an inversion unit configured to invert the first beam relative to the second beam prior to the beams being received by the optical mixing unit, and wherein the inversion unit comprises one or more reflecting members.

13. An optical system as claimed in claim 12, wherein the optical system comprises a reflecting member adjustment mechanism configured to adjust the orientation and/or position of at least one of the one or more reflecting members.

14. An optical system as claimed in claim 1, wherein the nonlinear optical medium comprises a nonlinear optical crystal.

15. An optical system as claimed in claim 1, wherein the optical system comprises a phase matching mechanism configured to substantially phase match the first, second and output beams.

16. An optical system as claimed in claim 15, wherein the phase matching mechanism comprises an optical mixing unit adjustment mechanism configured to adjust the orientation and/or position of the optical mixing unit or part thereof.

17. An optical system as claimed in claim 16, wherein the optical mixing unit adjustment mechanism is adapted to adjust the orientation and/or position of the nonlinear optical medium to substantially phase match the first, second and output beams.

18. An optical system as claimed in claim 17, wherein the optical mixing unit adjustment mechanism is adapted to rotate the nonlinear optical medium to substantially phase match the first, second and output beams.

19. An optical system as claimed in claim 1, wherein the optical mixing unit comprises one or more focussing members configured to focus the first and second beams received by the optical mixing unit.

20. An optical system as claimed in claim 1, wherein the optical system comprises a collimator configured to narrow the output beam.

21. An optical system as claimed in claim 1, wherein the optical system comprises a polariser configured to polarise the beam of incident radiation received by the optical system.

22. An optical system as claimed in claim 1, wherein the first and second beams and the output beam all lie substantially in a plane.

23. An optical system as claimed in claim 22, wherein the plane is substantially horizontal or vertical.

24. (canceled)

25. An optical system as claimed in claim 1, wherein the optical system comprises at least one spatial chirp unit configured to spatially chirp the incident radiation prior to inversion of the first beam relative to the second beam, and wherein the at least one spatial chirp unit is configured to spatially chirp the beam of incident radiation in a first plane and the first and second beams form an angle in a second plane where the first and second beams are incident on the optical mixing unit, the first plane being perpendicular to the second plane.

26. An optical system as claimed in claim 25, wherein the first plane is substantially horizontal and the second plane is substantially vertical.

27. An optical system as claimed in claim 1, wherein the optical system is configured to receive a beam of incident radiation in the form of laser radiation, for example a pulse of laser radiation.

28-38. (canceled)
